(19) United States
(12) Patent Application Publication
(10) Pub. No.: US 2014/0132442 A1
(43) Pub. Date: May 15, 2014

(54) POSITIONING DEVICE CAPABLE OF DETECTING THREE-DIMENSIONAL MOVE TRACE AND THE DETECTING METHOD THEREOF

(71) Applicant: KINPO ELECTRONICS, INC., New Taipei City (TW)

(72) Inventors: WEN-HSIN LO, NEW TAIPEI CITY (TW); CHIA-CHIN TSAI, NEW TAIPEI CITY (TW)

(73) Assignee: KINPO ELECTRONICS, INC., NEW TAIPEI CITY (TW)

(21) Appl. No.: 13/748,679

(22) Filed: Jan. 24, 2013

(30) Foreign Application Priority Data
Nov. 12, 2012 (TW) 101142086

(51) Int. Cl. G01S 19/47

(52) U.S. Cl. CPC G01S 19/47
USPC 342/357.3

(57) ABSTRACT

A positioning device capable of detecting three-dimensional move trace including a GPS module, an acceleration detecting module, and a computing unit is illustrated. The GPS module acquires global position information of the positioning device. The acceleration detecting module continuously detects three-dimensional acceleration based on movements of the positioning device, and calculates three-dimensional vectors of the positioning device accordingly. The computing unit is coupled with the GPS module and the acceleration detection module. The computing unit generates plane position information according to the global position information and a plurality of short three-dimensional traces according to the three-dimensional vectors. The computing unit further generates a plurality of short-distance traces according to the plane position information and the plurality of three-dimensional traces, and provides a three-dimensional moving trace via combining the plurality of short-distance traces.

### BACKGROUND OF THE INVENTION

1. Field of the Invention

The present disclosure relates to a positioning device and a method thereof; in particular, to a positioning device capable of detecting three-dimensional path and the method of detecting the three-dimensional path.

2. Description of Related Art

People who like to go hiking, mountain climbing, or rock climbing would usually carry a positioning device with them when performing the above-mentioned activities. Except for measuring temperature, atmospheric pressure, or physical parameters of the exerciser, the positioning device is also used for navigating and recording the path where the exerciser passed.

Most positioning devices use coordinates via Global Position System (GPS) to provide navigation and path detection functions. However, GPS signals are often constraint by positions of the satellites in the sky, and therefore GPS is not powerful in providing accurate height information or vertical displacements of the positioning device corresponding to surface of the ground. Generally speaking, errors of the height information provided via GPS would relatively greater than those of plane position information. For climbers or hikers, it is difficult to use GPS to detect accurate changes of height of the way they pass, so that vertical displacements of the exercisers are not able to be traceed or recorded by such general positioning devices.

Although some other positioning devices are embedded with barometers inside to assist in measuring changes of height of the positioning devices, barometers are still sensitive to external weather condition and the design of the barometers. Therefore, it is still not easy to precisely measure and record the changes of height when the positioning devices move with the exercisers.

### SUMMARY OF THE INVENTION

Hence, the present disclosure provides a positioning device capable of detecting three-dimensional move trace including a GPS module (Global Position System module), an acceleration detecting module, and a computing unit. The GPS module is configured to acquire global position information of the positioning device. The acceleration detecting module continuously detects changes of three-dimensional acceleration based on movements of the positioning device, and calculates three-dimensional vectors of the positioning device accordingly. The computing unit is coupled with the GPS module and the acceleration detection module. The computing unit generates plane position information according to the global position information and a plurality of short three-dimensional traces according to the three-dimensional vectors. The computing unit further generates a plurality of short-distance traces according to the plane position information and the plurality of three-dimensional traces, and provides a three-dimensional moving trace via combining the plurality of short-distance traces.

Additionally, another embodiment of the present disclosure provides a detecting method for detecting three-dimensional move trace, which can be applied to the above-mentioned device. The method includes steps of: receiving global position information acquired by the GPS module; receiving three-dimensional vectors calculated from three-dimensional acceleration based on movements of the positioning device; generating a plane position information according to the global position information and a plurality of three-dimensional traces according to the three-dimensional vectors; generating a plurality of short-distance traces based on the plane position information and the plurality of three-dimensional traces; and providing a three-dimensional moving trace by combining the plurality of short-distance traces.

In summary, the device and method of the present disclosure provide both horizontal moving data and vertical moving data of a positioning device against the surface of the ground, and further provide three-dimensional moving trace of the positioning device.

For further understanding of the present disclosure, reference is made to the following detailed description illustrating the embodiments and examples of the present disclosure. The description is only for illustrating the present disclosure, not for limiting the scope of the claim.

### BRIEF DESCRIPTION OF THE DRAWINGS

FIG. 1 shows a block diagram of a positioning device capable of detecting three-dimensional move trace according to one embodiment of the present disclosure;

FIG. 2 shows a schematic diagram of plane moving trace generated based on plane position information according to one embodiment of the present disclosure;

FIG. 3 shows a schematic diagram of three-dimensional trace according to one embodiment of the present disclosure;

FIG. 4 shows a schematic diagram of three-dimensional moving trace according to one embodiment of the present disclosure; and

FIG. 5 shows a flow diagram of three-dimensional move trace detecting method according to one embodiment of instant disclosure.

### DETAILED DESCRIPTION OF PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

### One Embodiment of the Positioning Device

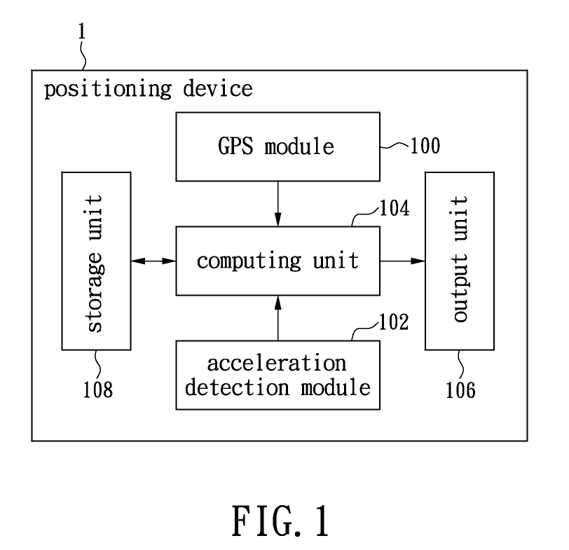

Referring to FIG. 1, FIG. 1 shows a block diagram of a positioning device capable of detecting three-dimensional path according to one embodiment of the present disclosure. The positioning device may include a GPS module 100, an acceleration detection module 102, and a computing unit 104. The GPS module 100 and the acceleration detection module 102 are separately coupled to the computing unit 104.

The GPS module 100 is configured for receiving global position information which may include longitude and latitude. The GPS module 100 is capable of providing quite accurate global position information which errors may be controlled within a few meters or even smaller. Thus, it can be pretty precise to locate the plane position of the positioning device 1 via global position information.

The acceleration detection module 102 may be a three-dimensional accelerometer for detecting three-dimensional acceleration caused by movement of the positioning device 1, and accordingly calculating three-dimensional vectors of the positioning device 1. The moving velocity and three-dimensional displacements of the positioning device 1 can be calculated based on several three-dimensional vectors of the positioning device 1, and thus the horizontal displacements of as well as the vertical displacements of the positioning device 1 may be computed may be determined through the three-dimensional vectors. The acceleration detection module 102 in the present embodiment may be a gravity sensor (G-sensor). G-sensor is capable of sensing the tilt of the positioning device 1. Therefore, when a user carries the positioning device 1 with him, the computing unit 104 may determine the user is moving upward or downward via the tilt of the positioning device 1.

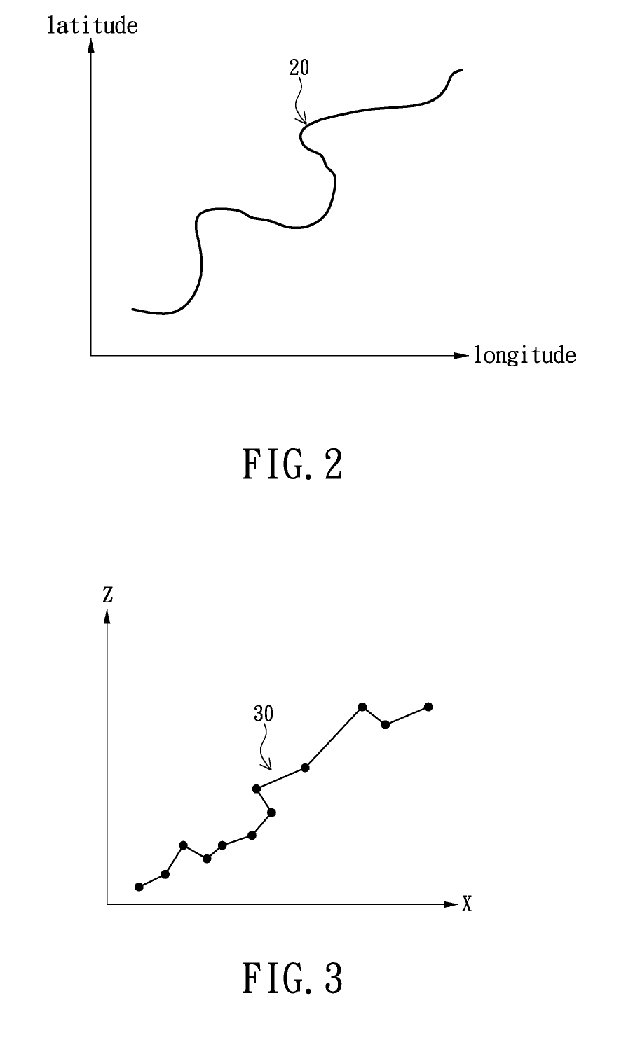

The computing unit 104 may be an embedded controller, a micro controller, or a center processing unit, used for receiving the global position information to generate a 2d position information. Said 2d position information may be the 2d coordinates composed of longitude and latitude. Please refer to FIG. 2 which shows an exemplary schematic diagram of the trace. The horizontal axis shown in FIG. 2 may represent the longitude axis while the vertical axis may represent the latitude axis, and the 2d plane surface corresponds to the surface of the Earth. When the GPS module 100 continuously detects the global position information, the computing unit 104 may determine the 2d moving trace of the positioning device 1 based on the received 2d position information. If the 2d moving trace is visualized, a user may see a section of 2d moving trace 20 as shown in FIG. 2 which displays the locations where the positioning device 1 has passed and moving directions along the trace.

The computing unit 104 further receives the three-dimensional vectors calculated by the acceleration detection module 102 to generate the three-dimensional trace of the positioning device 1 accordingly. Please refer to an exemplary trace diagram shown in FIG. 3. For simplifying the figure, FIG. 3 shows only two dimensions composed by two of the three dimensional axes of the three-dimensional trace. The horizontal axis in FIG. 3 refers to one of the plane axis of the positioning device 1 (called x axis), and the vertical axis refers to the height axis of the positioning device 1 (called z axis). The three-dimensional trace may include changes of plane positions and corresponding changes of vertical positions. In other words, the three-dimensional vectors detected by the acceleration detection module 102 allow the computing unit 104 to determine not only horizontal movement information of the positioning device 1 but also to determine the rise or fall of the positioning device 1 based on its vertical movement information. If the trace computed based on the three-dimensional vectors is visualized, it may be displayed as the three-dimensional trace 30 shown in FIG. 3.

In particularly speaking, the acceleration detection module 102 may calculate a general vector Aβ of three dimensions in a time duration ΔT based on the three-dimensional accelerometer, and accordingly get a velocity vector V and position vector S of the positioning device 1 in the time duration ΔT:

V=V₆₈+Aβ·ΔT

S=V_{ε·ΔT+}½·Aβ·ΔT

wherein, V is the last velocity in ΔT; V_{ε} is the initial velocity in ΔT and the last velocity of the former ΔT. After a series of time duration ΔT, a plurality of position vectors S_{μ} may be determined:

S_{μ}=V_{μ-1}·ΔT_{μ}+½·Aβ_{μ}·ΔT_{μ}²,

wherein μ is an integer.

Computing unit 104 may compute each component S_{μx}, S_{μy}, and S_{μz} of the position vector as being projected on three-dimensional axes. Connecting every components of two of the three dimensions (e.g. the plane formed by two axes corresponding to the display of the positioning device 1) would generate the plane curve of the three-dimensional trace, in which the three-dimensional trace of the positioning device 1 would be completed after combining components of the third dimension.

However, the acceleration detecting module 102 only detects the movements of the positioning device 1 and generates relative position information. Therefore though the three-dimensional movements of the positioning device 1 may be detected, it is not able to determine where the positioning device 1 starts to move, rise, or fall. In other words, the three-dimensional vectors from the acceleration detection module 102 are not enough to provide absolute position information when the positioning device 1 moves.

Thus, the computing unit 104 may combine the plane position information which give absolute position and the three-dimensional trace give three-dimensional displacement information to get the three-dimensional path of the positioning device 1. The three-dimensional path includes not only information about changes of height but each plane position of the positioning device 1 in the three-dimensional path.

It is worth to mention, the three-dimensional vectors generated by the acceleration detecting module 102 are figured based on the three-dimensional acceleration which is an outcome of velocity integrated with time. The error caused by the integral may be accumulated with distances. If the accumulated error becomes significant, the calculated three-dimensional trace would gradually diverge, in which the three-dimensional path finally becomes inconsistent with real trace of the positioning device 1. In other words, proper indication position is necessary for adjusting the three-dimensional path and preventing from diverging. Therefore in the present embodiment, the above-mentioned three-dimensional path is a short distance trace adjusted at every moving distance, so as to keep the accuracy of the short distance trace.

Since the global position information received by the GPS module 100 provides quite precise plane position information, and therefore the computing unit 104 may use received global position information to compute moving distance of the positioning device 1. Each time the positioning device 1 is determined to move to the moving distance, the computing unit 104 receives new global position information and generates new plane position information as an indication position for re-locating the positioning device 1. The computing unit 104 may separately compute multiple short-distance traces based on combinations of the indication positions and three-dimensional vectors from the acceleration detecting module 102.

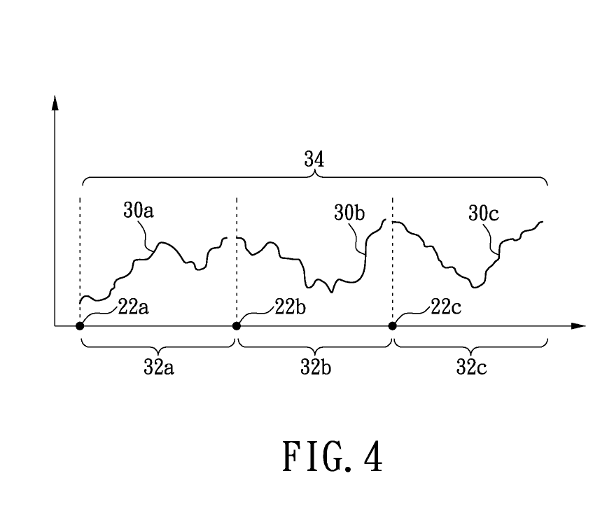

Please refer to an exemplary schematic diagram of the trace shown in FIG. 4. For simplifying the figure, FIG. 4 depicts a two dimensional coordinates composed by two of the three axes of the short-distance trace. The horizontal axis represents the longitude axis while the vertical axis represents the height against the level of the Earth. In other words, each coordinate in FIG. 4 corresponds to a specific degree of longitude, a specific degree of latitude, and a specific value of height though the degree of latitude is not shown in the figure. The computing unit 104 may receive global position information and consequently generate the indication position 22a and determine a plane absolute position of the positioning device 1 (i.e. the degree of longitude and latitude). Following, the computing unit 104 may receive a series of three-dimensional vectors to get a three-dimensional trace 30a starting from the indication position 22a. The short-distance trace 32a is generated after combining the indication position 22a with the three-dimensional trace 30a.

The computing unit 104 may keep calculating new short-distance traces after the positioning device 1 moves the moving distance, and provide a plurality of short-distance traces as shown in FIG. 4. Each short-distance trace 32a, 32b, and 32c shown in FIG. 4 combines an indication position and a three-dimensional trace: 22a and 30a; 22b and 30b; 22c and 30c. The computing unit 104 may connect the short-distance traces 32a to 32c in order, so that a long distant three-dimensional moving trace 34 is generated. Therefore the moving trace including changes of height of the positioning device 1 is provided. Meanwhile the deviation of the three-dimensional moving trace can be fixed by updating indication positions via global position information.

Please refer to FIG. 1 again. The positioning device 1 in the present embodiment may further include an output unit 106 and a storage unit 108 coupled to the computing unit 104, respectively. The storage unit 108 may be non-volatile memory chip like Flash memory or EEPROM for storing the short-distance traces computed by the computing unit 104. The storage unit 108 may further store electronic map. The output unit 106 may be the LCD of the positioning device 1 for displaying data outputted by the computing unit 104. The computing unit 104 may match the three-dimensional moving trace based on the plurality of short-distance traces with the electronic map in the storage unit 108, and output the three-dimensional curve of the three-dimensional moving trace with the electronic map to the output unit 106. Therefore, the user of the positioning device 1 can review his moving trace including height information on the screen.

### Another Embodiment of the Positioning Device

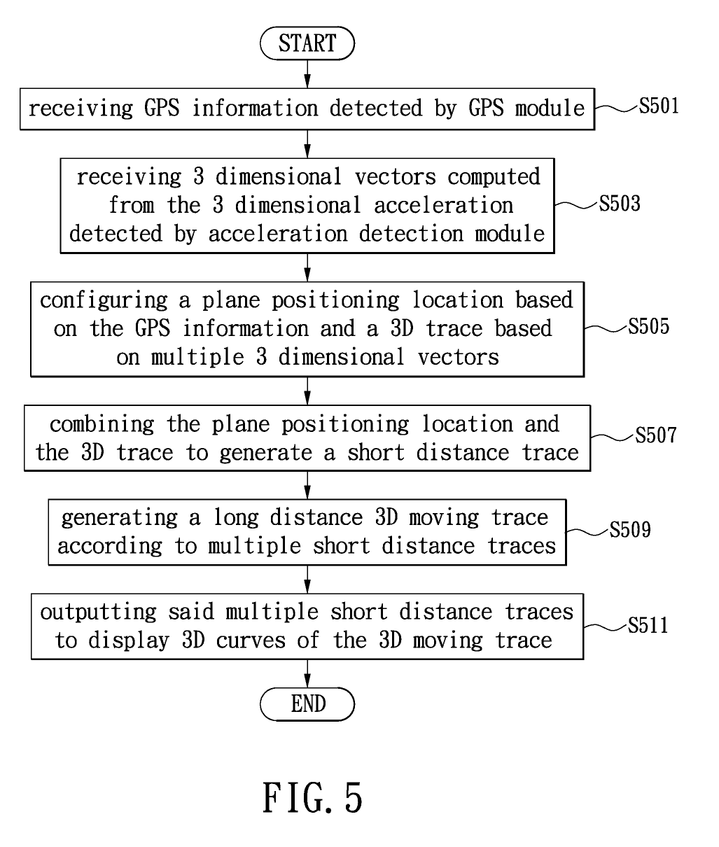

Please refer to FIG. 5, which shows a flow diagram of a three-dimensional path detecting method according to one embodiment of the instant disclosure. The detecting method in the present embodiment may be applied by the positioning device as shown in FIG. 1, and therefore please refer to FIG. 1 jointly for better understanding of the steps below.

The computing unit 104 of the positioning device 1 receives global position information detected by the GPS module 100 (S501), and receives three-dimensional vectors that are calculated from three-dimensional acceleration generated upon movement of the positioning device 1 by the acceleration detecting module 102 (S503).

The computing unit 104 may then acquire plane position information based on the global position information and a three-dimensional trace of the positioning device 1 based on multiple three-dimensional vectors (S505). Wherein the plane position information acquired from the global position information may be the longitude coordinate and the latitude coordinate representing the absolute position of the positioning device 1. The computing unit 104 may calculate a moving velocity (V) according to the received three-dimensional vector (Aβ) and a time duration (ΔT) for the acceleration detecting module 102 detecting the three-dimensional acceleration, and generate the three-dimensional trace based on the moving velocity (V), thethree-dimensional vector (Aβ), and the time duration (ΔT).

The computing unit 104 may combine the plane position information and the three-dimensional trace to acquire a short-distance trace (S507). In other words, after combining the plane position information revealing the absolute plane position with the three-dimensional trace which provides only relative displacement of the positioning device 1, the short-distance trace can tell the absolute horizontal location as well as the rises and falls of the positioning device 1. Accumulated errors of the three-dimensional vectors occurred along with the distance. In order to fix the deviation in time, the computing unit 104 may compute the distance that the positioning device 1 moves based on the global position information detected by the GPS module 100, and take detected plane position information as an indication position every time the positioning device 1 moves a predetermined moving distance. The computing unit 104 may compute a new three-dimensional trace started from the new indication position, and generate a new short-distance trace accordingly.

After acquiring a plurality of short-distance traces, the computing unit 104 may connect the plurality of short-distance traces to provide a three-dimensional moving trace (S509). The three-dimensional moving trace includes not only records of displacement on the ground of the positioning device 1 but also records of differences in height against the level. The three-dimensional moving trace can be saved in the storage unit 108 for searching Finally, the computing unit 104 may output several short-distance traces to the output unit 106 according to data saved in the storage unit 108, so that the user of the positioning device 1 may review the three-dimensional curve of the three-dimensional moving trace (S511).

Please refer to former embodiment for features similar or equivalent to those in the embodiment.

### Possible Effects of the Embodiments

According to the above-mentioned embodiments, the positioning device and the three-dimensional path detecting method are capable of detecting, recording, and displaying three-dimensional changes of the positioning device when it is moving. Therefore said embodiments solve the existed problem that most positioning devices gives plane position but fails to precisely measure vertical displacement.

Besides, according to the above-mentioned embodiments, the positioning device and the three-dimensional path detecting method can adjust the trace relied on the data detected by acceleration detecting module via global position information, preventing the deviation of the three-dimensional trace and keeping the measured trace is consist with the real moving pattern.

Furthermore, the above-mentioned device and method may store and output the calculated three-dimensional moving trace, so that users can visually observe the three-dimensional curve corresponding to the moving path of the positioning device.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A positioning device capable of detecting a three-dimensional path, comprising:
a GPS module, for acquiring global position information of the positioning device;
an acceleration detection module, continuously detecting changes of three-dimensional acceleration based on movements of the positioning device and calculating three-dimensional vectors of the positioning device accordingly;
a computing unit, coupled with the GPS module and the acceleration detection module, wherein the computing unit generates a plane position information according to the global position information and a plurality of short three-dimensional traces according to the three-dimensional vectors, in which generates a plurality of short-distance traces according to the plane position information and the plurality of three-dimensional traces,
wherein the computing unit provides a three-dimensional moving trace via combining the plurality of short-distance traces.

2. The positioning device according to claim 1, wherein the computing unit determines a positioning location at every moving distance based on the global position information, and generates the plurality of short-distance traces according to the positioning locations and the plurality of three-dimensional traces.

3. The positioning device according to claim 1, wherein the acceleration detection module is a G-sensor.

4. The positioning device according to claim 1, further comprising:
an output unit, coupled with the computing unit for receiving the plurality of short-distance traces, wherein the output unit outputs three-dimensional curves of the three-dimensional moving trace based on the plurality of short-distance traces.

5. The positioning device according to claim 1, wherein the computing unit computes a moving velocity of the positioning device based on the three-dimensional vectors and a time duration for detecting the three-dimensional acceleration, and computes the three-dimensional trace based on the moving velocity, the three-dimensional vector and the time duration.

6. A three-dimensional path detecting method, adapted to a positioning device having a GPS module, an acceleration detection module, and a computing unit, comprising:
receiving global position information acquired by the GPS module;
receiving three-dimensional vectors calculated from changes of three-dimensional acceleration based on movements of the positioning device;
generating a plane position information according to the global position information and a plurality of three-dimensional traces according to the three-dimensional vectors;
generating a plurality of short-distance traces based on the plane position information and the plurality of three-dimensional traces; and
providing a three-dimensional moving trace by combining the plurality of short-distance traces.

7. The method according to claim 6, wherein the step of generating the plurality of short-distance traces comprises:
determining a positioning location at every one moving distance based on the global position information; and
generating the plurality of short-distance traces according to the determined positioning locations and the plurality of three-dimensional traces.

8. The method according to claim 7, wherein whether the positioning device moves the moving distance is determined via accumulating the distance the positioning device moves according to the acquired global positioning information.

9. The method according to claim 6, after providing the three-dimensional moving trace, further comprising:
outputting three-dimensional curves of the three-dimensional moving trace to an output unit.

10. The method according to claim 6, wherein the step of generating the plurality of three-dimensional traces according to the three-dimensional vectors comprises:
computing a moving velocity of the positioning device based on the three-dimensional vectors and a time duration for detecting the three-dimensional acceleration; and
computing the three-dimensional trace based on the moving velocity, the three-dimensional vector and the time duration.
